(19) United States
(12) Patent Application Publication
(10) Pub. No.: US 2011/0004523 A1
(43) Pub. Date: Jan. 6, 2011

(54) Method and Apparatus for Preferential Determination and Display of Points of Interest

(75) Inventors: Thomas J. Giuli, Ann Arbor, MI (US); Krishnaswamy Venkatesh Prasad, Ann Arbor, MI (US); Joe Phillip Pierucci, West Bloomfield, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/498,004

(22) Filed: Jul. 6, 2009

(51) Int. Cl. G01C 21/36; G06Q 30/00

(52) U.S. Cl. 705/14.58; 701/200; 701/207; 705/14.4

(57) ABSTRACT

A method and apparatus for preferential determination and display of points of interest are provided. The points of interest can be determined based on a variety of non-proximity based factors, including, but not limited to, time of day, temperature, etc. The automatically determined points of interest can then be displayed for a user on a display associated with a vehicle-based computing system. Advertisements may also be selected and displayed based on incoming signals, and points of interest associated with displayed advertisements may be displayed.

### BACKGROUND

1. Technical Field

The illustrative embodiments generally relate to a method and apparatus for preferential determination and display of points of interest.

2. Background Art

GPS and other navigation systems are often equipped with the ability to display points of interest (POI). These are typically named locations (restaurant name, business name, etc.) that may be of interest to a user.

For example, a TOMTOM navigation device provides a feature the user can select to display points of interest. Once the POI feature is selected, the user can then choose a variety of POI types. Some non-limiting examples include: POI Near You, POI Near Destination, POI Near Home, POI Along Route, POI In City.

Once a POI type has been selected, the system then displays a subset selection. For example, on a TOMTOM, selection of POI Near You brings up the choices: Any POI Category, Restaurant, Gas Station, Hotel/Motel, and Airport (numerous other categories are also available from a sub-menu).

Selecting, for example, Restaurant, provides a list of restaurants, ordered by proximity to the driver's present location. Selecting Any POI Category brings up a typing menu where a user is asked to enter part or all of a POI name.

### SUMMARY

In one illustrative embodiment, a vehicle-based computing system includes a vehicle-based processor, to control a monitoring system and one or more storage locations to store data for use by the processor.

The processor is operable to execute one or more routines. The execution of the one or more routines results in the processor automatically selecting one or more non-proximity based factors for consideration in determining one or more points of interest (POIs) for display.

The execution also results in the processor evaluating the selected one or more factors and determining one or more POIs to display based at least in part on the evaluating the selected one or more factors.

The execution further results in the processor displaying one or more of the one or more POIs determined by the determining.

In another illustrative embodiment a vehicle-based computing system includes a vehicle-based processor, to control a monitoring system and one or more storage locations to store data for use by the processor.

In this illustrative embodiment, the processor is operable to automatically select a plurality of points of interest (POIS) based on a plurality of non-proximity based factors.

The processor is further operable to instruct display of one or more of the plurality of POIs on a display.

The selection of POIS for display includes the step of selecting one or more POIs associated with a first factor for display, based at least in part on a first proximity associated with the first factor.

The system may then display the selected POIs in an order based at least in part on proximity to a predetermined location and repeat the steps of selecting and displaying for each remaining factor. This repeating can continue at least until either:

no room remains on the display; or no POIs remain to be displayed.

Further, in this embodiment, a second proximity associated with a second factor of the remaining factors is different than the first proximity associated with the first factor.

In yet another illustrative embodiment, a vehicle-based computing system includes a vehicle-based processor, to control the monitoring system and one or more storage locations to store data for use by the processor.

In this illustrative embodiment, the processor is operable to interpret a signal associated with an incoming radio frequency signal as an advertisement signal.

The processor is further operable to check a database to see if there is a stored advertisement associated with the advertisement signal. The processor is also operable to retrieve the advertisement associated with the advertisement signal and instruct display of the advertisement on a display.

### BRIEF DESCRIPTION OF THE DRAWINGS

Other aspects and characteristics of the illustrative embodiments will become apparent from the following detailed description of exemplary embodiments, when read in view of the accompanying drawings, in which:

FIG. 1 shows an exemplary illustrative vehicle-based communication system with wireless capability;

FIGS. 2A-C show exemplary illustrative processes for automatically displaying one or more points of interest;

FIG. 3A shows an exemplary illustrative process for selecting one or more weighted/ranked POIs;

FIG. 3B shows an exemplary illustrative process for displaying one or more POIs;

FIG. 4 shows an exemplary illustrative process for connecting to and receiving factors from a remote device;

FIG. 5 shows an exemplary illustrative process for connecting to and receiving factors from a vehicle sensor; and

FIG. 6 shows an exemplary illustrative process for displaying an automatically determined and ordered POI list.

### DETAILED DESCRIPTION

The present invention is described herein in the context of particular exemplary illustrative embodiments. However, it will be recognized by those of ordinary skill that modification, extensions and changes to the disclosed exemplary illustrative embodiments may be made without departing from the true scope and spirit of the instant invention. In short, the following descriptions are provided by way of example only, and the present invention is not limited to the particular illustrative embodiments disclosed herein.

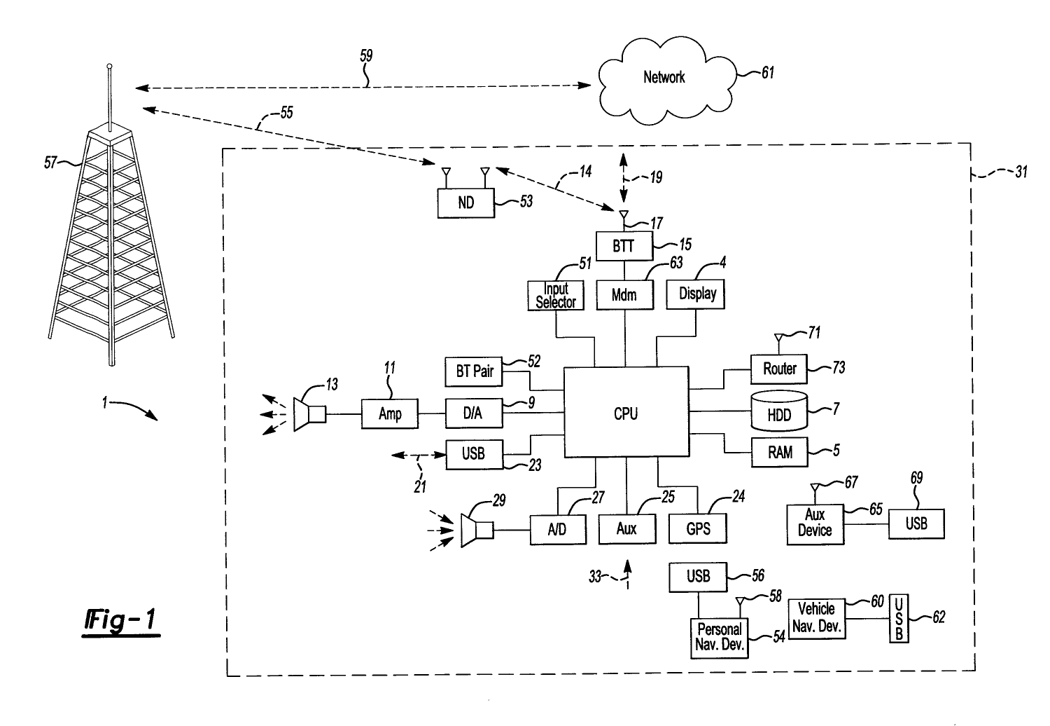

FIG. 1 illustrates an example block topology for a vehicle based computing system 1 for a vehicle 31. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, etc.). The nomadic device can then be used to communicate 59 with a network 61 outside the vehicle 31 through, for example, communication 55 with a cellular tower 57.

Exemplary communication between the nomadic device and the BLUETOOTH Transceiver is represented by signal 14.

Pairing a nomadic device 53 and the BLUETOOTH transceiver 15 can be instructed through a button 52 or similar input, telling the CPU that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53.

Alternatively, it may be desirable to include an onboard modem 63 in order to transfer data between CPU 3 and network 61 over the voice band. In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is affixed to vehicle 31.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73.

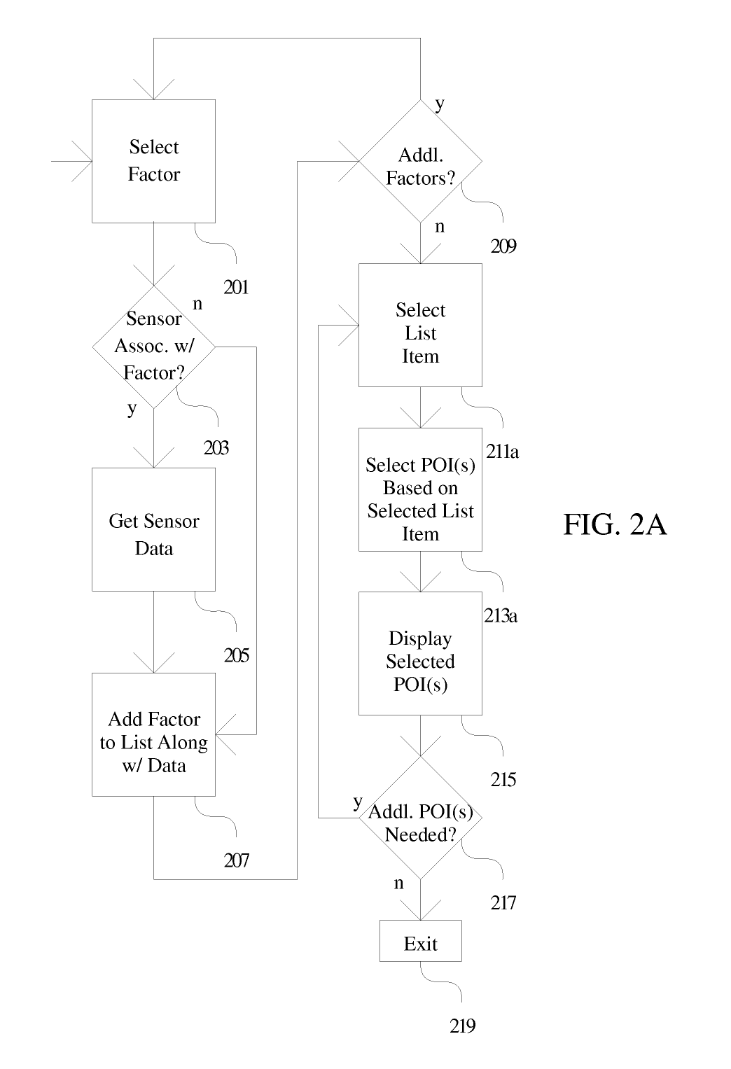

FIGS. 2A-C show exemplary illustrative processes for automatically displaying one or more points of interest. In this illustrative embodiment, a vehicle based computing system selects a first factor for consideration 201. This illustrative embodiment provides one demonstrative method of automatically selecting and ordering points of interest for display, based at least in part one or more factors. For example, factors could include, but are not limited to, time of day, temperature, fuel level, icy condition detection, tire pressure, oil gauge, user medical conditions, and user preferences.

In one illustrative example, a factor could be the present temperature. Another factor to be considered could be the day of the week. Still further, the time of day could be considered. For example, if it was 95 degrees Fahrenheit on Saturday at noon, the system could “guess” that the user might like to know where a beach or public pool facility was. Another option could be public golf courses. Accordingly, if these factors were selected, the system may provide a list of beaches, public pools and golf courses as points of interest.

The factors that are selected can be predetermined or random. For example, a user could set up a list of factors that user considers to be relevant on a website or other remote location, and have that list uploaded to a vehicle based computing system. Or the user could interact with a vehicle based computing system to select relevant factors.

Weightings could also be assigned to various factors. For example, two factors might be a medical device sensor and the time of day. POIs related to the medical device sensor could include, for example, convenience stores if the sensor was a blood glucose sensor. POIs related to the time of day could include, for example, restaurants to be displayed during meal times. Since the blood glucose sensor would likely be of higher priority than the time of day, it may be desirable to have that factor weighted more heavily (or higher ranked, if ranking is used over weighting).

Any suitable system may be used for selection of factors to be considered when automatically determining POIs to be displayed.

After the factor has been selected, the system determines whether a sensor is associated with the factor 203. This could be, for example, a gas level sensor, a temperature sensor, etc. If there is a sensor associated with the factor, then the sensor data is retrieved 205. Whether or not a sensor is associated with the factor, the factor is then added to a list of factors to be considered 207 (along with sensor data if necessary).

The system then checks to see if additional factors remain to be considered 209. If factors remain, the above process may be repeated until no factors remain. Once no factors remain for consideration, the system selects one or more listed factors 211a and then selects POIs based at least in part on selected list items 213a. It may also be the case that a plurality of factors are considered simultaneously. For example, if temperature and time of day are considered, a list of temperature related factors could be assembled and then that list could be rechecked against the time of day (as one example, it is unlikely someone is looking for a public pool at 1 AM, regardless of the present temperature).

After the POIs relevant to the selected factor(s) are selected, the relevant POIs are displayed or otherwise presented to the user. This presentation could be made on a vehicle navigation display, made to a display wired or wirelessly connected to the vehicle based computing system, made over the audio system, etc.

Once the first POIs are presented, the system checks to see if additional factors remain for consideration 217. If factors remain, the system repeats the above process for remaining factors, otherwise the system exits the routine 219.

FIG. 2B shows an exemplary alternative selection of factors from the factor list, based on a weighting/ranking system. Once the list of relevant factors has been assembled 201-209, the system could, for example, selected the highest weighted list item(s) 211b. In the previously presented example using blood glucose and temperature, the system would first consider blood glucose. If a medical device in communication with the vehicle based communication system indicated a low level of blood glucose, the system could display points of interest related to raising a blood glucose level (and perhaps provide an accompanying alert to the user). If the blood glucose level was within normal parameters, however, no points of interest may be displayed.

In step 213b, the system displays X POIs associated with each factor. In this illustrative embodiment, X is a predetermined number and prevents a single factor from overwhelming the list of factors. For example, it may not be necessary to display (or otherwise present) forty five locations at which a low blood glucose level can be corrected. The five closest locations might be sufficient.

Next, the system might display X locations based on time of day. X may vary by factor, or be fixed for all factors. For example, the user may desire five locations to rectify low blood glucose levels, but want twenty possible restaurant options. Further, the locations are not necessarily displayed based on proximity to a user. For example, if the user left work at 4:30 PM and had a one hour commute home, the system may display restaurants that are located around a location to which the user is predicted to be proximate at 5:00 PM. The determination of how to select and display certain POIs within a factor-relevant list can be made dynamically and can be based on any number of preset conditions. Or a simple “proximate to user,” “proximate to destination,” etc. condition could be used, for example.

FIG. 2C shows a third exemplary sub-process of the exemplary process shown in FIG. 2A. In this illustrative embodiment, weighted list items are again selected 211c, and all relevant POIs within a certain distance (of the user, of a spot on the route, of the destination, etc.) are displayed 213c. Again, the X distance could vary based on the factor, or could be constant for all factors. For example, X could be large for blood glucose, to ensure at least one destination is found (X could also vary until Y locations are found, in a combination of steps from FIGS. 2B and 2C). On the other hand, the user may not want to stray too far from a route for food, so only locations within a small X distance of the determinate location may be shown.

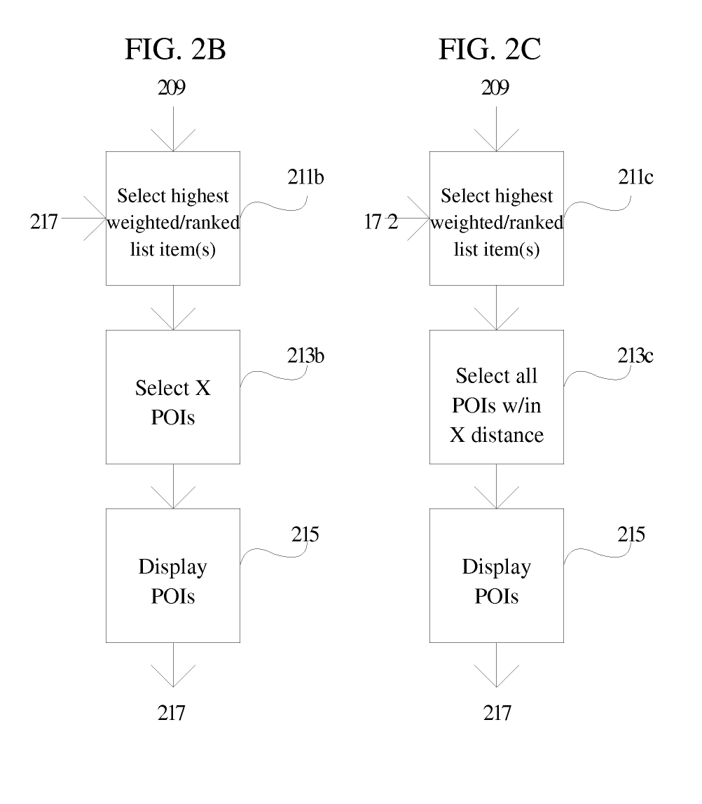

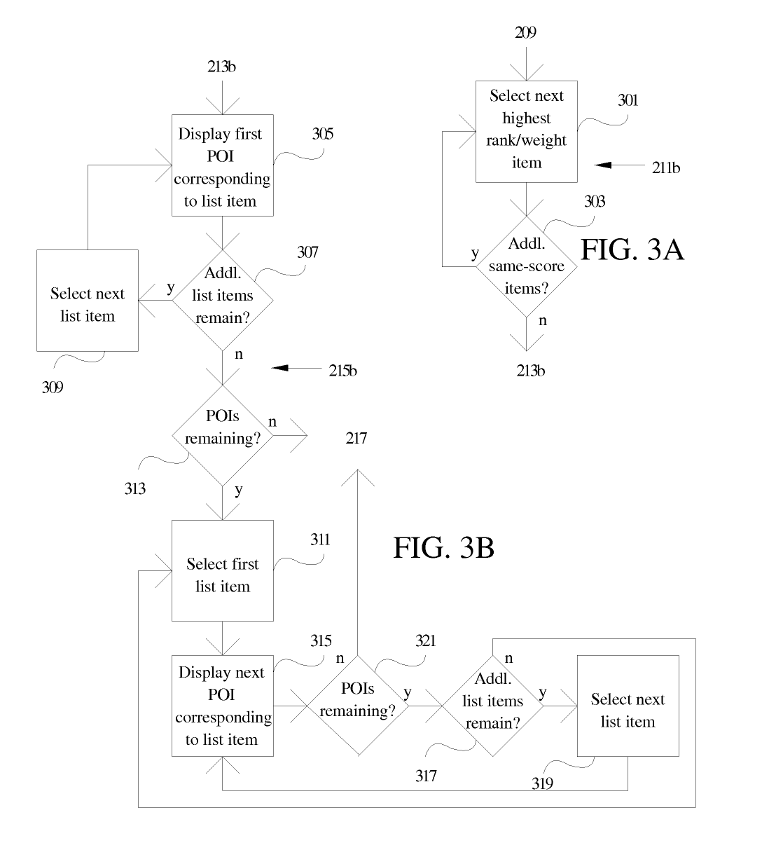

FIG. 3A shows an exemplary illustrative process for selecting one or more weighted/ranked POIs 211b. First, the system selects the next highest ranked/weighted list item (factor) 301. Then the system checks to see if there are any other list items that have the same weight or ranking 303. If so, the system continues to select items until all of the highest ranked items remaining with the same rank are selected. Then the system can proceed to POI presentation 213b.

FIG. 3B shows an exemplary illustrative process for displaying one or more POIs 215b. After selecting POIs relevant to the selected factor(s) in step 213b, the system displays the first POI corresponding to a first list item 305. Then, the system checks to see if there are additional list items for consideration 307. If list items (e.g., without limitation, list items that have a similar weight or ranking) remain, then a next list item is selected 309 and a first POI corresponding to that list item is displayed.

Otherwise, the system checks to see if any POIs remain to be displayed 313. If not, the system proceeds to 217. If one or more POIs remain, the first list item is again selected 311 and a next POI with respect to that item is displayed 315. After ensuring that POIs remain 321, the system checks to see if there are additional list items to be considered 317. If so, the next list item is selected 319 and a corresponding next POI is displayed. If no other list items exist (or remain), the first list item is again selected and the next POI is displayed.

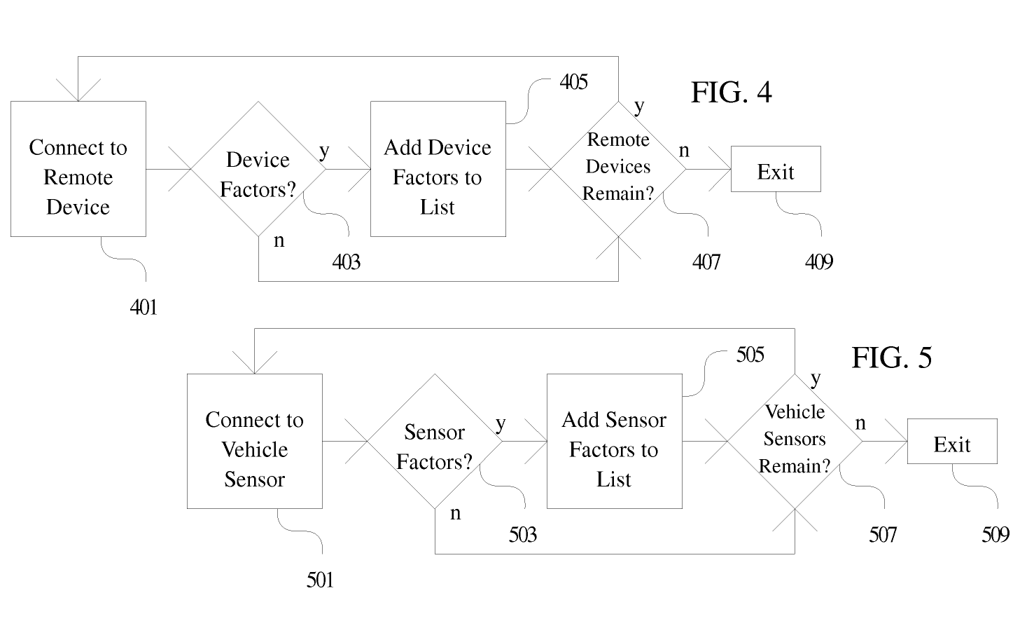

FIG. 4 shows an exemplary illustrative process for connecting to and receiving factors from a remote device. In this illustrative embodiment, the vehicle based computing system first connects to a remote device 401. This connection could be wired or wireless. The remote device can be any device connectable to the system, and include, but not be limited to, cellular phones, PDAs, navigation devices, medical devices, wellness devices, etc.

After connection to the device, the system checks to see if there are any factors associated with the device that are to be used for POI selection 403. For example, a cellular phone may not have any factors associated with it, but a glucose monitor may. The system can do this check for all devices connected to the system, without having to prompt the user to connect a different device for checking, thus ensuring that all connected devices are checked and considered.

If there are no factors associated with the device, the system checks to see if any remote devices remain for checking 407. If there are factors associated with the device, the system may add those factors to a list for consideration 405 and then proceeds to checking for remaining devices 407.

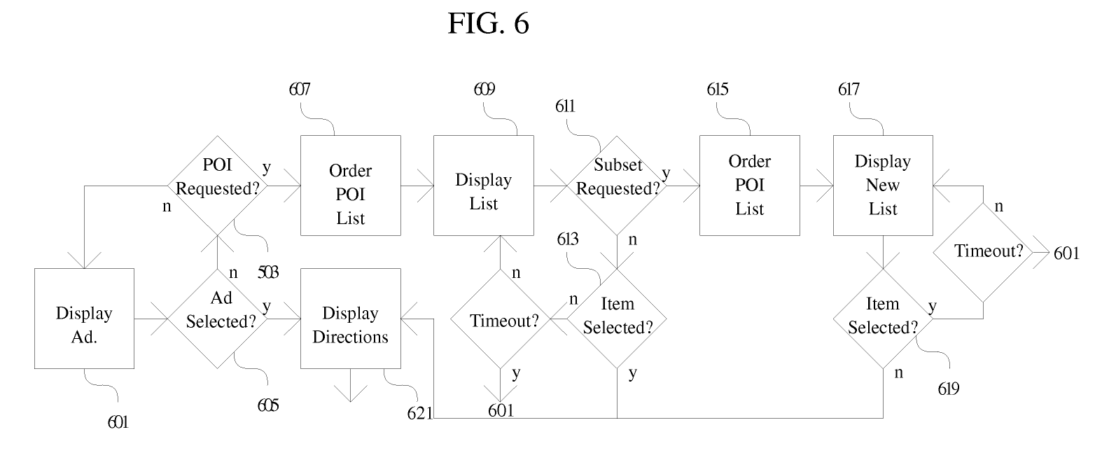

FIG. 5 shows an exemplary illustrative process for connecting to and receiving factors from a vehicle sensor.

In this illustrative embodiment, the vehicle based computing system first connects to a vehicle sensor 501. The sensor can be any vehicle sensor suitable to provide data for POI selection, or the system can check all accessible vehicle sensors. A non-limiting list includes gasoline sensors, tire pressure sensors, oil sensors, etc.

After connection to the sensor, the system checks to see if there are any factors associated with the sensor that are to be used for POI selection 503. If the system runs through all available sensors, then all relevant factors can be added to a list for consideration automatically, without user intervention.

If there are no factors associated with the sensor, the system checks to see if any sensors remain for checking 507. If there are factors associated with the sensor, the system may add those factors to a list for consideration 505 and then proceeds to checking for remaining sensors 507.

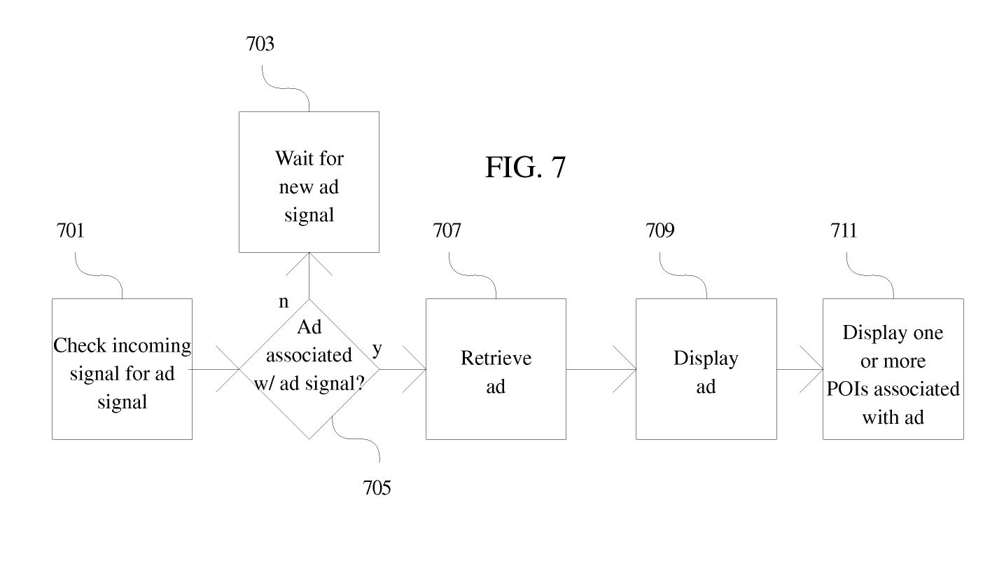

FIG. 6 shows an exemplary illustrative process for displaying an automatically determined and ordered POI list. In this illustrative embodiment, a vehicle navigation display or other connected display is used to present the POIs. In this embodiment, one or more advertisements (which can also be displayed based on all the criteria listed herein, in at least the manners listed herein according to at least the methods listed herein) are displayed 601.

In this embodiment, the display is further a user-interactable display (e.g., without limitation, a touch display). Accordingly, the system checks to see if a user has selected a particular advertisement 605. If an advertisement is selected, the system proceeds to display directions to the selected location. For example, if a HOME DEPOT advertisement is selected, the system could display directions to the nearest HOME DEPOT. Or the system could display a list of HOME DEPOTS, a list of HOME DEPOTS and similar stores, etc., from which a particular destination could be selected.

If no advertisement has been selected, the system checks to see of POIs have been requested 603. This request could be a user based request to display POIs, or one or more factors may have triggered an automatic system request for POI display. If no POI display is requested, the system returns to displaying advertisements 601, in this illustrative embodiment.

If a POI has been requested, the system then proceeds to order 607 and display 609 a POI list. This could be done, for example, in the manners suggested by FIGS. 2A-C. Also, any combination of steps from FIGS. 2A-C may be combined into another display process, and additional steps can be added or removed as desired.

Once a POI list is displayed, it may be possible that a number of categories are also displayed, based on relevant sensor factors. Accordingly, these categories or subsets may be user selectable. If a subset is not selected 611, but if a particular POI is selected 613, then directions to that POI may be displayed 621.

If no item is selected, the system may proceed to checking if a timeout has occurred 612 (e.g., without limitation, the subset list has been displayed for a given period of time). If a timeout has occurred, the system may return to list display 601. If there is no timeout, the list continues to be displayed 609.

If a subset is requested, the system orders a POI list 615 of POIs in that subset and presents the new list 617. Again, the system checks to see if an item is selected 619, and whether a timeout has occurred 618. Checking for timeouts may be excluded if desired; the system could rely on a “back” button or some other methodology to return to a previous state. If an item from the subset is selected, directions to the selected POI are displayed 621.

FIG. 7 shows an exemplary illustrative advertisement display process. In this illustrative embodiment, one or more advertisers have arranged to have a static, audio or video advertisement stored in a provider database (which could be located, for example, in a vehicle or at a remote location). When an advertisement plays on a radio station, the system checks to see if an advertisement signal is associated with the advertisement 701. If the advertisement signal is present, the system checks to see if an advertisement in a database is associated with the signal 705.

If no advertisement is associated with the signal (because, for example, without limitation, the advertiser has not elected to be associated with that service provider), the system waits for a new advertisement signal 703.

If an advertisement is associated with the signal, the system retrieves the advertisement 707 and displays the advertisement 709. This can be done, for example, on a vehicle display or a navigation device display.

In addition, the vehicle may display one or more points of interest associated with the advertisement 711.

For example, if a commercial for MCDONALDS was playing on the radio, at the same time, the vehicle display (if, for example, without limitation, not otherwise engaged) might display a static MCDONALDS advertisement. At the same time, a portion of the display may show one or more buttons, corresponding to, for example and without limitation: 1) Display the location of a MCDONALDS near the present location; 2) Display the location of a MCDONALDS along a predetermined route; or 3) Display the location of a MCDONALDS near a destination.

This could allow a user to easily reroute to a business advertised on the radio without having to take time away from focusing on the road to input a destination selection. Instead, a single touch or voice command could be used to easily select a new destination.

Additionally, this could provide advertisers an opportunity to target people who may not have a complete grasp of a local language. For example, if a person who only spoke Spanish was driving a car and a MCDONALDS advertisement came on the radio in English, that advertisement may be lost on that consumer. But, since a visual advertisement also pops up, the user might recognize the MCDONALDS logo and correspondingly elect to route to a MCDONALDS.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed:

1. A vehicle-based computing system comprising:
a vehicle-based processor, to control a monitoring system;
one or more storage locations to store data for use by the processor;
wherein the processor is operable to execute one or more routines, the execution of the one or more routines resulting in the processor:
automatically selecting one or more non-proximity based factors for consideration in determining one or more points of interest (POIs) for display;
evaluating the selected one or more factors;
determining one or more POIs to display based at least in part on the evaluating the selected one or more factors; and
displaying one or more of the one or more POIs identified by the determining.

2. The computing system of claim 1, wherein the one or more non-proximity based factors includes a time of day.

3. The computing system of claim 1, wherein the one or more non-proximity based factors includes an outside temperature.

4. The computing system of claim 1, wherein the one or more non-proximity based factors includes a fuel level.

5. The computing system of claim 1, wherein the one or more non-proximity based factors includes an icy condition.

6. The computing system of claim 1, wherein the one or more non-proximity based factors includes a tire pressure level.

7. The computing system of claim 1, wherein the one or more non-proximity based factors includes an oil level.

8. The computing system of claim 1, wherein the one or more non-proximity based factors includes a wellness monitor state.

9. The computing system of claim 1, wherein the one or more factors to be selected are determined by a user.

10. The computing system of claim 1, wherein the execution of the one or more routines further resulting in the processor:
weighing or ranking the selected one or more factors against each other; and wherein the determining further includes determining one or more POIs to display based at least in part on a comparison between weighted or ranked factors.

11. The computing system of claim 10, wherein the weighting or ranking of the one or more factors is user determined.

12. The computing system of claim 1, wherein the determining further includes determining one or more POIs to display based at least in part on proximity to a location.

13. The computing system of claim 12, wherein a value used for the proximity varies by factor.

14. The computing system of claim 1, wherein the execution of the one or more routines further resulting in the processor:
selecting a predetermined number of POIs to be displayed for one or more of the one or more selected factors.

15. The computing system of claim 14, wherein the predetermined number of POIs varies between at least two of the one or more selected factors.

16. A vehicle-based computing system comprising:
a vehicle-based processor, to control a monitoring system;
one or more storage locations to store data for use by the processor;
wherein the processor is operable to interpret a signal associated with an incoming radio frequency signal as an advertisement signal;
wherein the processor is further operable to check a database to see if there is a stored advertisement associated with the advertisement signal; and
wherein the processor is further operable to retrieve the advertisement associated with the advertisement signal and instruct display of the advertisement on a display.

17. The vehicle-based computing system of claim 16, wherein the processor is further operable to instruct display of one or more point of interest (POI) selections associated with the advertisement.

18. The vehicle-based computing system of claim 17, wherein the POI selections include at least one of: a POI near the user, a POI along a predetermined route, or a POI at a predetermined destination.

19. The vehicle-based computing system of claim 18, wherein the POI selections correspond to an advertising business providing the advertisement.

20. The vehicle-based computing system of claim 19, wherein the database is stored in at least one of the storage locations.

21. The vehicle-based computing system of claim 19, wherein the database is stored remotely.

22. A computer readable storage medium storing instructions that, when executed by a processor of a machine reading the computer readable storage medium, cause the processor to:
automatically select one or more non-proximity based factors for consideration in determining one or more points of interest (POIs) for display;
evaluate the selected one or more factors;
determine one or more POIs to display based at least in part on the evaluation of the selected one or more factors; and
display one or more of the one or more POIs.

23. A vehicle-based computing system comprising:
a vehicle-based processor, to control the monitoring system;
one or more storage locations to store data for use by the processor;
wherein the processor is operable to interpret a signal associated with an incoming radio frequency signal as an advertisement signal; and
wherein the processor is operable to instruct display of one or more point of interest (POI) selections associated with the advertisement.
